(19) United States
(12) Patent Application Publication
(10) Pub. No.: US 2005/0199665 A1
(43) Pub. Date: Sep. 15, 2005

(54) Roof-top carrier

(75) Inventor: Stephen J. Plzak, Bryn Mawr, PA (US)

Correspondence Address: LAW OFFICES OF ARTHUR E. JACKSON, P.O. BOX 88, HOPEWELL, NJ, 08525, US

(73) Assignee: Design Research & Development Corporation

(21) Appl. No.: 10/797,812

(22) Filed: Mar. 10, 2004

(51) Int. Cl. A45F 3/12; A41F 15/02; B60R 9/00

(52) U.S. Cl. 224/318

(57) ABSTRACT

Provided, among other things, is roof-top carrier comprising: a resilient support pad having a bottom adapted to rest on the roof and a top; either (i) two or more support members extending across the bottom of the support pad or through the support pad situated to retain support-retaining strap gear, or (ii) a support member extending across a long axis of the bottom of the support pad or through the support pad along the long axis, the support members of (i) or (ii), in conjunction with the support-retaining strap gear, retaining the support pad to the roof; the support-retaining strap gear; and if option (i) pertains, load-retaining strap gear adapted to engage the support-retaining strap at two ends of the support pad to retain a load to the support pad.

The present invention relates to devices for securing items to a roof, such as the roof of a vehicle such as a car or truck.

Roof-top carriers tend to come in metallic forms requiring substantial installation, or quick to install forms. These quick install forms tend to generate noise due to vibrating strap segments, such that highway speeds create near unbearable noise. One way to reduce this noise is to empirically find ways to twist the straps to reduce the sympathetic vibrations causing the noise. This twisting makes installation more difficult, and increases the width of the straps at the door seals (if installing on a vehicle). Experiment has shown that this noise can be reduced without resort to twisting using the roof-top carriers described below. These and other advantages are provided by the various embodiments described below.

Relatedly, a method of securing a boat mast or other equipment during transport of the boat on a trailer is provided.

### SUMMARY OF THE INVENTION

Provided, among other things, is roof-top carrier comprising: a resilient support pad having a bottom adapted to rest on the roof and a top; either (i) two or more support members extending across the bottom of the support pad or through the support pad situated to retain support-retaining strap gear, or (ii) a support member extending across a long axis of the bottom of the support pad or through the support pad along the long axis, the support members of (i) or (ii), in conjunction with the support-retaining strap gear, retaining the support pad to the roof; the support-retaining strap gear; and if option (i) pertains, load-retaining strap gear adapted to engage the support-retaining strap at two ends of the support pad to retain a load to the support pad.

In certain embodiments, the support-retaining strap gear is adapted to be situated 5 cm (or 3 cm, or 1 cm) or less from the roof. In certain embodiments, the support-retaining strap gear is adapted to be situated a distance from the bottom of ⅓rd, ¼^{th}, ⅕th, ⅙th or less of a distance defined from the bottom to the top.

Further provided is a method of securing boating gear (such as a mast or mast and folded sail) of a boat while carrying the boat on a carrier such as a trailer, the method comprising: securing a portion of the boat to the carrier with a strap that comprises two affixed rings, the securing locating the rings to two separate locations relative to a center line of the boat; and securing the boating gear between the rings with strapping gear. The strapping gear optionally comprises one or more buckles, which are optionally substantially made of plastic.

### BRIEF DESCRIPTION OF THE DRAWINGS

FIGS. 1A and 1B display one embodiment of a roof-top carrier.

FIG. 2 shows another embodiment of a roof-top carrier.

FIGS. 3A and 3B show straps for use on a roof-top carrier.

FIG. 4A shows another embodiment of a roof-top carrier, while

FIG. 4B shows the straps for such a roof-top carrier.

FIG. 5 shows another embodiment of a roof-top carrier.

FIGS. 6 and 7 show another embodiment of a roof-top carrier.

FIG. 8 shows another embodiment of a roof-top carrier.

FIG. 9 shows another embodiment of a roof-top carrier with two distinct pads.

FIGS. 10A and 10B demonstrate a method of securing items on a boat secured to a support.

### DETAILED DESCRIPTION OF THE INVENTION

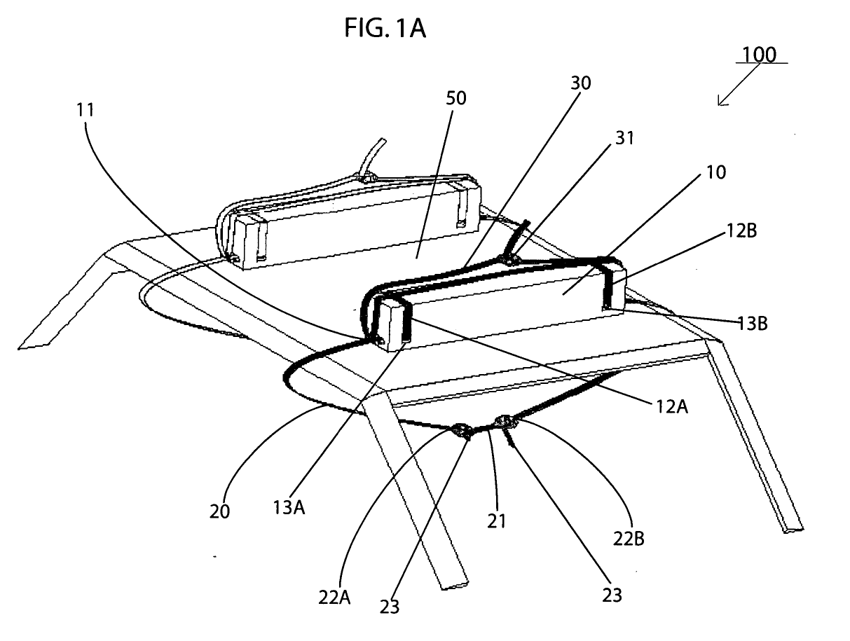

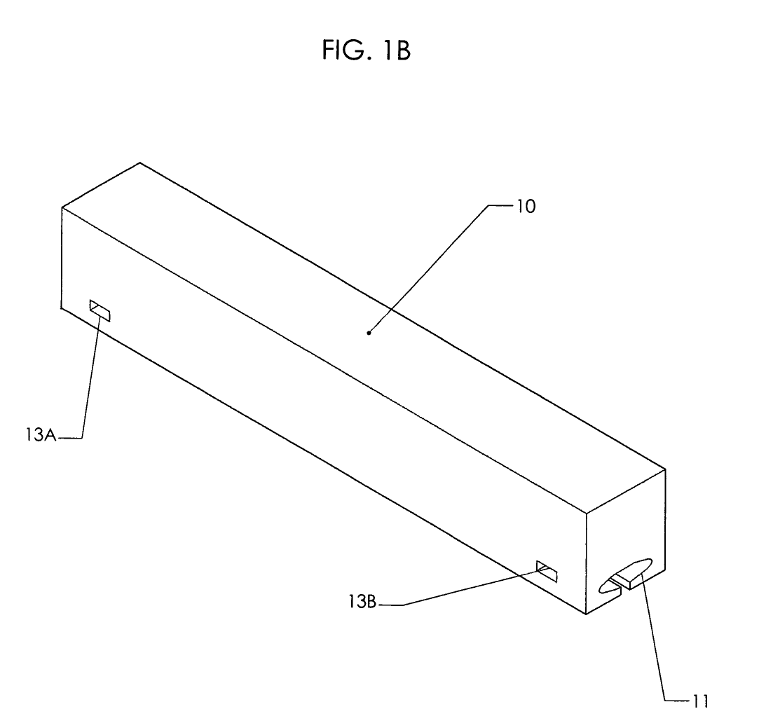

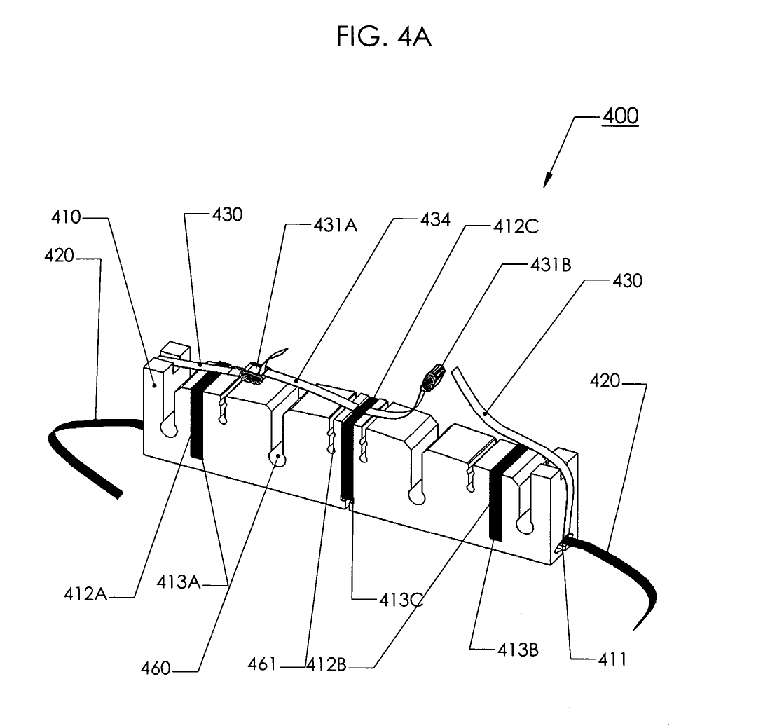

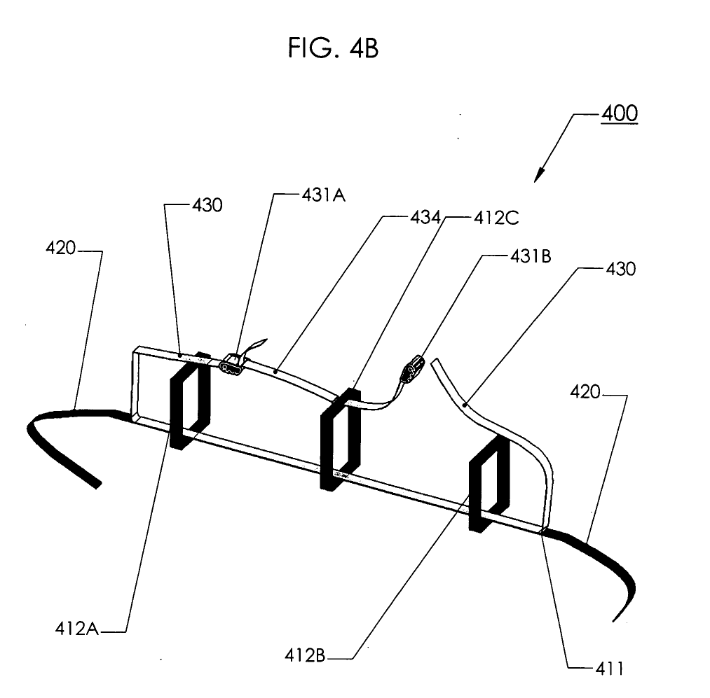

FIG. 1A shows a perspective view of an embodiment of the roof-top carrier 100. Resilient pad 10 is secured to a roof such as a car or truck roof 50 by support-retaining strap gear including strap 20. In this illustrative embodiment, support-retaining strap gear 20 is situated in channel 11, which is a slot adapted to accommodate and engage a bar of a roof rack. Support members 12A and 12B are, in this embodiment, straps extending through conduits 13A and 13B, respectively, and around the support pad 10. The conduits, which in this case are slots through the resilient pad, serve to restrict the support members from shifting position on the support pad. (Conduits open to the bottom of the resilient pad are illustrated in FIGS. 4, 6 and 7.) Strap 20 of the support-retaining strap gear is looped over the support members 12A and 12B to retain it to the roof-top carrier. In this embodiment, load-retaining strap gear is a loop of strap 30 coupled by buckle 31, with the strap looped around strap 20 at both sides of the support pad 10. Support-retaining strap gear here comprises strap 20 adjustment strap 21 with buckles 22A and 22B. Buckles 22A and 22B engage the two ends 23 of strap 20, allowing the position of the adjustment strap 21 to be adjusted by adjusting the amount of each end of strap 20 engaged through the respective buckles. Thus, if this gear is positioned over the driver of a vehicle using the roof-top carrier, it can be shifted out of the way while maintaining overall tension.

FIG. 1B shows a perspective view of the support pad 10.

The support members in the illustrated embodiment are straps looped around the support pad, but they can be, for example, rods extending through the pad or strap segments adhered to the support pad. The support members allow the support-retaining strap gear to be rigged close to the roof on which the roof-top pad is engaged, thereby markedly reducing noise attendant to straps rigged a higher point.

While any buckle can be used, a preferred buckle is the Load Lock® fastener available form Design Research & Development Corporation, King of Prussia, Pa. This fastener is substantially made of plastic and comes in embodiments capable of retaining a 300 pound (13.6 kg) load using one inch webbing. Other exemplary buckles that can be used include commonly found metal or plastic cam style buckles and commonly found side release fasteners. Load-retaining strap gear or support-retaining strap gear can comprise bungee cord or shock cord, which may lack a buckle.

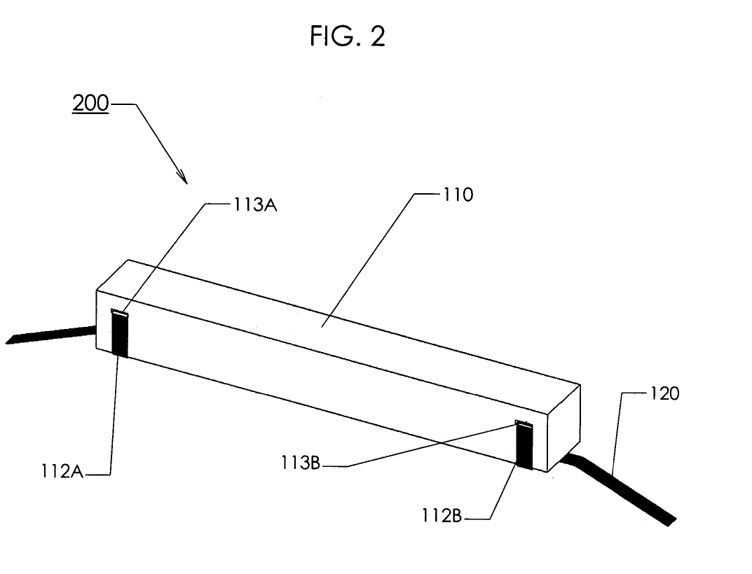

FIG. 2 shows a perspective view of a roof-top carrier 200 where support members 112A and 112B extend through conduits 113A and 113B located toward the top of support pad 110. Strap 120 of the support-retaining strap gear is looped through the support members 112A and 112B as it extends along the bottom of the support pad 110.

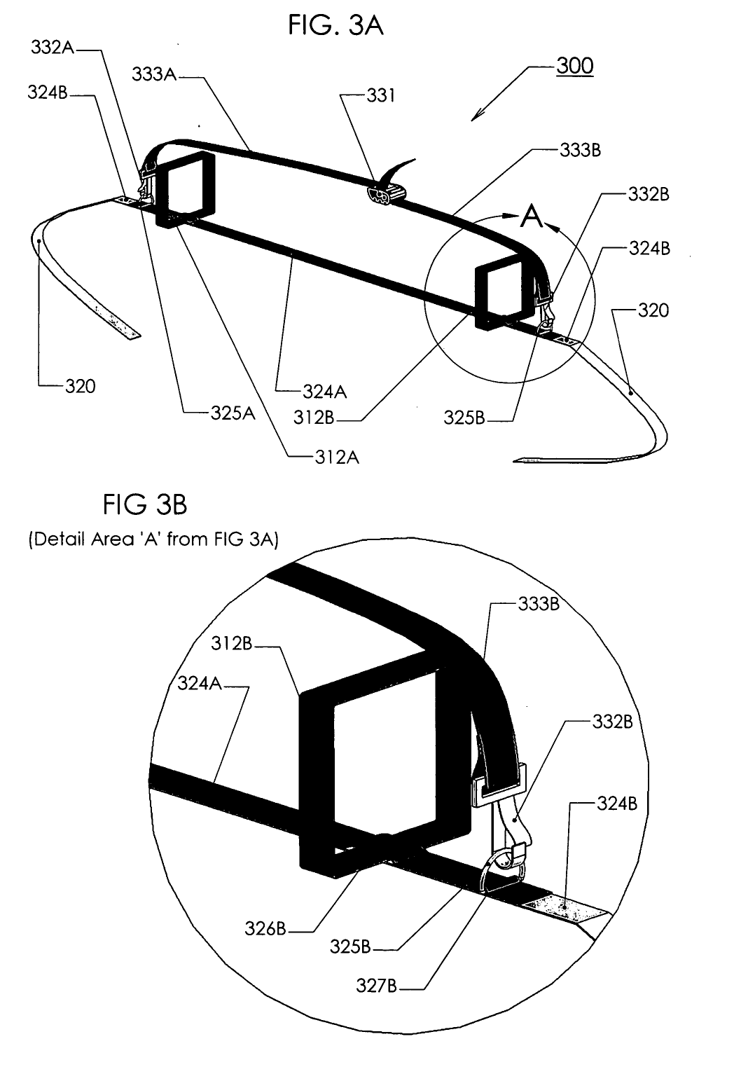

FIG. 3A shows straps in the positions suitable for engaging a support pad such as that of FIG. 1A, where the support-retaining strap gear includes segments of two straps, 324A and 324B, adhered together (such as sewn). FIG. 3B shows a blow up of the indicated region of FIG. 3A. Strap 324B can be contiguous with strap 320 (i.e., they may be segments of the same strap). The adhered straps serve to retain the positioning of strap 320 with respect to the support members 312A and 312B, which are retained between the two strap segments 324A and 324B at sleeves 326A and 326B. Rings 325A and 325B, such as D-rings, can be retained between the two straps 324A and 324B at slots 327A and 327B to locate the rings in a position appropriate for engaging strap 330 of the load-retaining strap gear. The so-located rings 325A and 325B are biased away from the roof, with the strap material separating the rings from the roof. Thus, where the rings are metal or the like, they are less likely to damage the roof. Load-retaining strap gear comprises, in this embodiment, clip 332A attached to strap 333A, which engages buckle 331. Buckle 331 is attached to strap 333B, which is attached at its other end to clip 332B. The clips can be releasable. Since clips can be more releasable when covered with frozen water, the use of clips in conjunction with the buckle can provide an alternative release mechanism after driving through winter weather.

FIG. 4A shows straps in the positions suitable for engaging a support pad such as that of FIG. 1A, where load-retaining strap gear comprises an centering strap 434 attached at its two ends to buckles 431A and 431B. The centering strap 434 is fixed in place by a third support member 412C. Buckles 431A and 431B engage strap 430, which is wrapped under resilient pad 410, as seen more clearly in FIG. 4B. Strap 430 can be stitched, glued, or otherwise affixed to strap 420. Gear-engaging slots 460 are adapted to accept pairs of skis laid base-to-base. Skis laid base-to-base typically bow apart at the center of the long axis, and slightly at the ends. The skis are typically placed in slots 460 at or near one of the contact points of the bow structure, but resilient pad 410 can generally deform to accommodate wider segments of the skis. Gear-engaging slots 461 are adapted to accept, in this example, the pole segments of two ski poles, which are favorably placed at the two wider subparts of the gear-engaging slots 461.

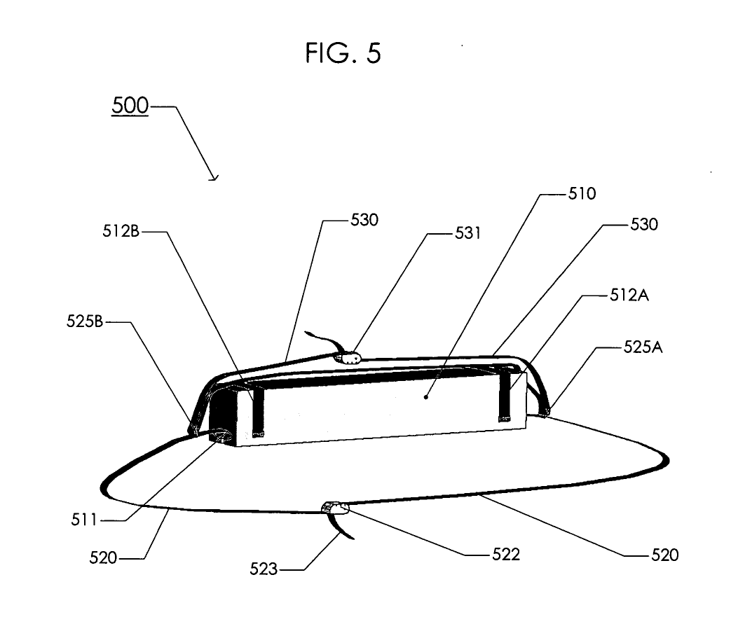

FIG. 5 shows an embodiment where the load-retaining strap gear includes D-rings 525A and 525B.

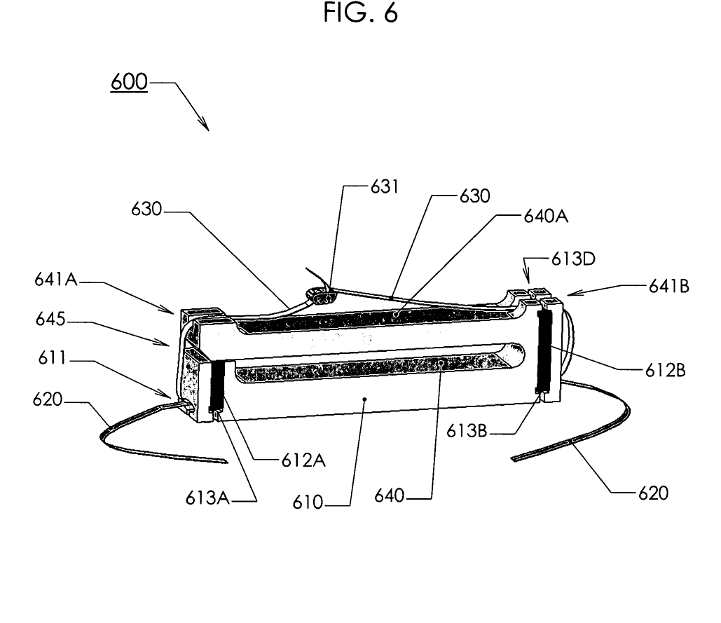

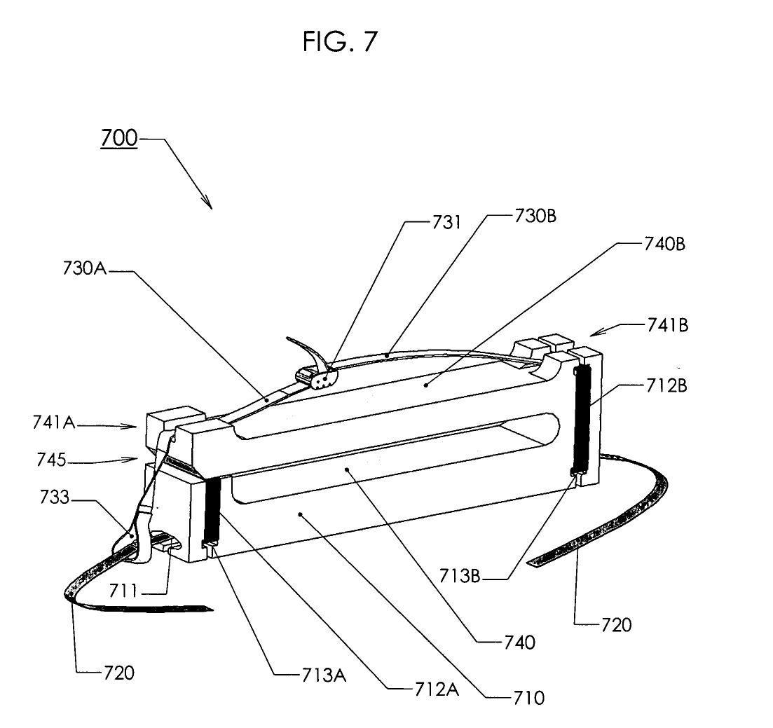

FIGS. 6 and 7 are embodiments adapted for carrying surfboards (or, possibly in somewhat different dimensions, snow boards, sail boards, kite boards or similarly shaped items). Slot 640 accommodates one board, while half slot 640A accommodates another. Slot 640 is accessed at opening 645. Slots 641A and 641B help lock the load-retaining strap gear in place. In embodiment 600 (FIG. 6), the strap 630 of the load-retaining strap gear is wrapped through channel 611. The strap 630 can be adhered (such as stitched) to strap 620. In embodiment 700, strap 730B is retained to the support-retaining strap gear by strap loop 733, while strap 730A is retained by another strap loop (not visible in this perspective).

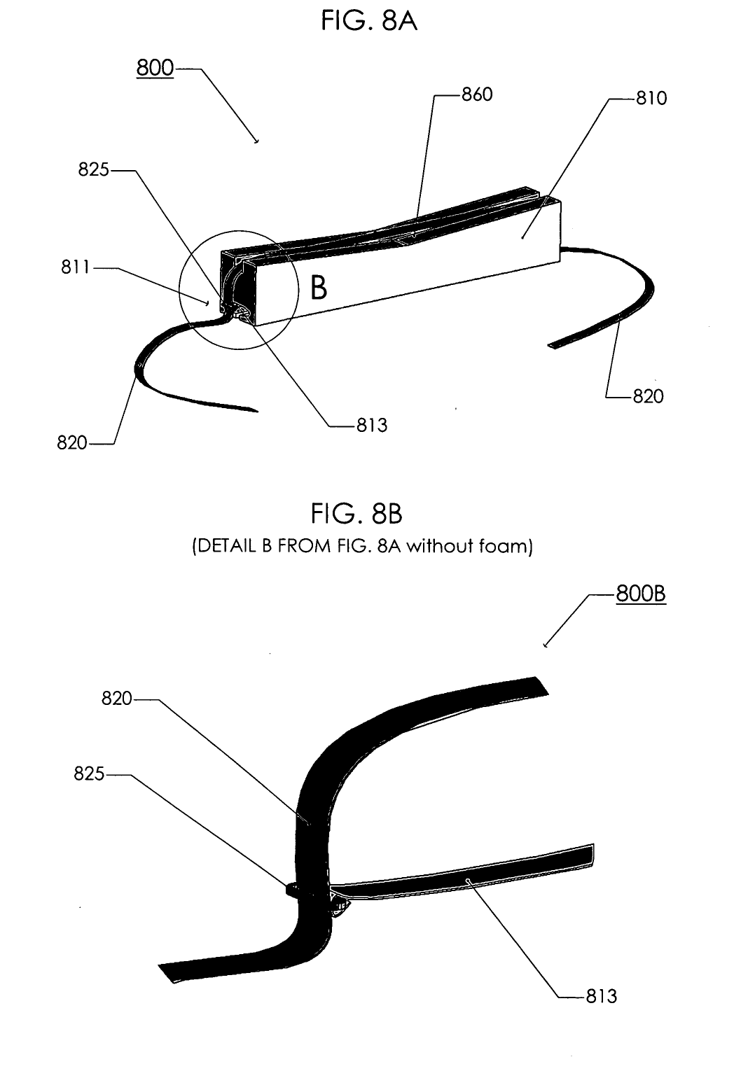

Another way to lower the profile of the straps on the roof is illustrated in FIGS. 8A and 8B. Support member (strap) 813 holds the support and load-retaining strap gear, here embodied in strap 820 to the support pad 810 while assuring that strap 820, outside the region of the support pad, remains closer to the roof than it would without support member 813. In the illustration, the holding connections are with rings 825. Such a slidable connection is useful where there is no strap adjustment on the top of the resilient pad 810. Any of the strap arrangements described above can be used in this embodiment. For example, if straps were clipped or buckled to rings 825, support strap gear otherwise as in another figure (e.g., FIG. 1A), and load-retaining strap gear as in one of the figures, could be used. Slot 860 is adapted for a boat, such as a canoe or kayak.

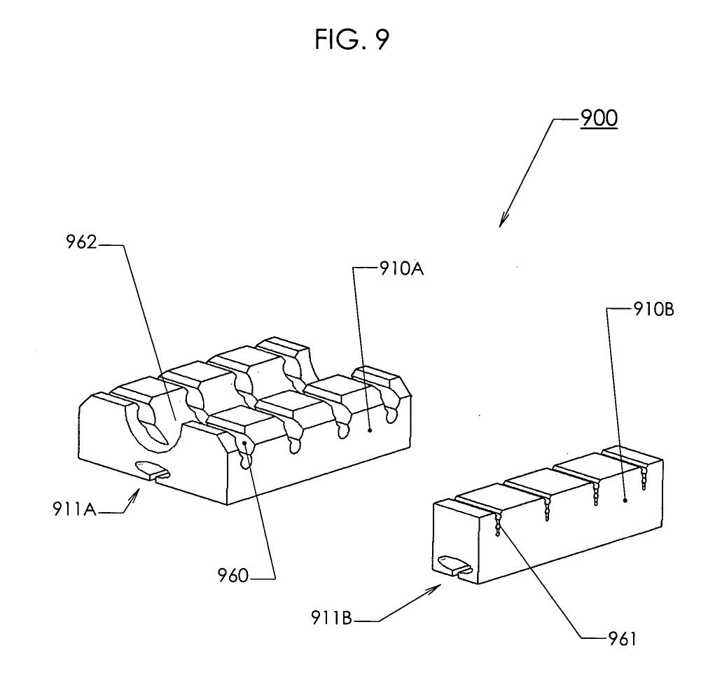

FIG. 9 shows resilient pad set 900. The smaller resilient pad 910B includes slots 961 adapted to hold the rod segments of fishing poles. Slots 960 hold rod segments from the thicker region close to where the reel fits. The reels, if present, fit into slots 962. The strap and support member arrangement is not shown, but can be any of those of the invention.

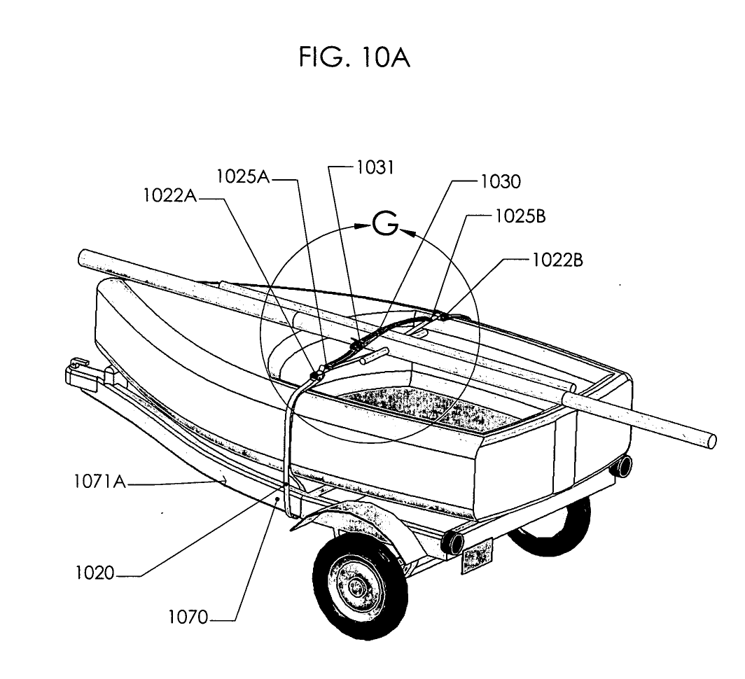

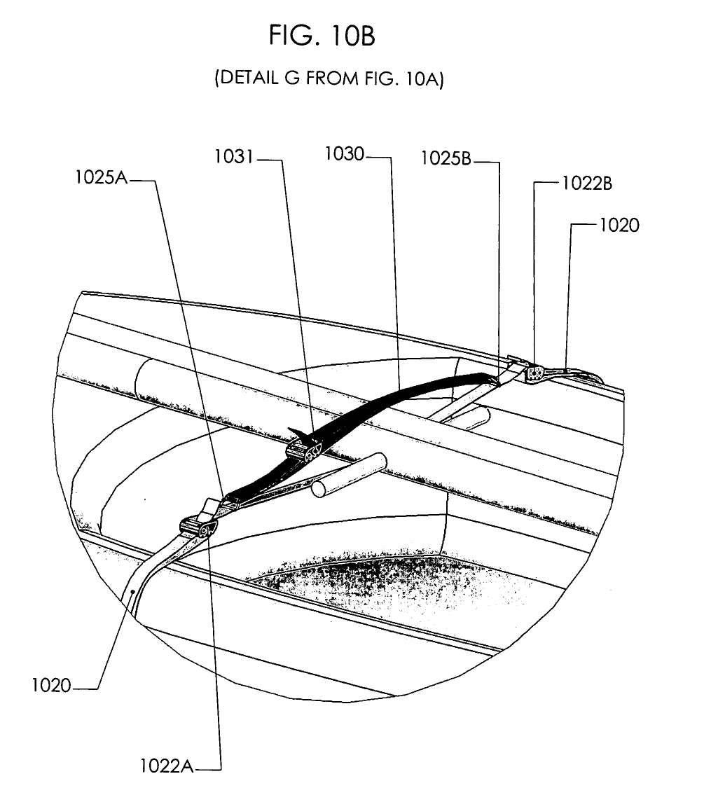

FIGS. 10A and 10B illustrate how items may be secured to a boat fitted to a carrier such as a boat trailer. The boat can be of any size that is fitted to a carrier, from jet skis or waverunners to much larger boats. Strap 1020 is looped at both ends to portion 1071 of trailer frame 1070. Buckles 1022A and 1022B are used to tighten the strap 1020. The strap can be substituted with multiple straps, and secured to fixed elements such as eye bolts of the carrier. Two D-rings 1025A and 1025B are used to secure load retaining strap gear that includes strap 1030 and buckle 1031. Other load retaining strap gear that can be used includes, for example, bungee cords and shock cords. The load retaining strap gear secures gear in a fixable location on the carried boat, such as at about the center line. Other boating gear that can be secured includes, for example, life vests, masts, masts with folded sails, and the like.

Where a number in a given figure for a given embodiment is not individually described, that number corresponds to element(s) identified by the same last two digits for another embodiment. Hence, element 530 is a strap forming part of the load-retaining strap gear as in the first illustrated embodiment.

Definitions

The following terms shall have, for the purposes of this application, the respective meanings set forth below.
buckle
A buckle is a device that joins two straps or two strap ends in a manner that allows the length of at least on strap end to be adjusted.
clip
A clip is a device that joins two straps or two strap ends in a manner not adapted to provide a mechanism for adjusting strap length.
distance defined from the bottom to the top
A “distance defined from the bottom to the top” is the distance at the outer edges of the support pad from the bottom to the average height of the support pad, with the average taken without account of slots that are as narrow or narrower than they are deep (see, e.g., the ski and ski pole slots illustrated). It will be understood that these distances and like measurements are measured from the outer part of the resilient pad, where separation from the top of the roof has a cost in noise generation.
resilient
A “resilient” support pad is one capable of (a) withstanding ordinary use as the support for a roof carrier without permanent deformation or rupture, and (b) compressing somewhat to conform to the shape of an item carried on the roof carrier.
strap
A strap is any material flexible enough to wrap around an object and suitable for use with a buckle. A strap can be a cord.
substantially made of plastic
A buckle is “substantially made of plastic” if the weight of plastic parts exceeds the weight of parts made of other materials.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. A roof-top carrier comprising:
a resilient support pad having a bottom adapted to rest on the roof and a top;
either (i) two or more support members extending across the bottom of the support pad or through the support pad situated to retain support-retaining strap gear, or (ii) a support member extending across a long axis of the bottom of the support pad or through the support pad along the long axis, the support members of (i) or (ii), in conjunction with the support-retaining strap gear, retaining the support pad to the roof;
the support-retaining strap gear; and
if option (i) pertains, load-retaining strap gear adapted to engage the support-retaining strap at two ends of the support pad to retain a load to the support pad.

2. The roof-top carrier of claim 1, comprising load-retaining strap gear (if not already present) and wherein the load-retaining strap gear comprises a strap and a buckle.

3. The roof-top carrier of claim 1, comprising load-retaining strap gear (if not already present) and wherein the load-retaining strap gear comprises two straps with loops for engaging the support-retaining strap.

4. The roof-top carrier of claim 1, wherein the support-retaining strap gear comprises two ring pieces adapted to be situated at each end of the support pad.

5. The roof-top carrier of claim 4, comprising load-retaining strap gear (if not already present) and wherein the load-retaining strap gear comprises two straps with clips for engaging the rings.

6. The roof-top carrier of claim 1, wherein a portion of the support-retaining strap gear adapted to engage the support pad comprises two strap segments sewn together.

7. The roof-top carrier of claim 6, wherein two ring pieces adapted for engaging load-retaining strap gear are retained between the two strap segments at locations adapted to be situated at each end of the support pad.

8. The roof-top carrier of claim 7, wherein the portion of the support-retaining strap gear is retained to the support pad by having the support members retained between the strap segments.

9. The roof-top carrier of claim 7, wherein the straps segments, support pad and support members serve to position the rings on top of the load-retaining strap gear and thereby away from the roof.

10. The roof-top carrier of claim 1, wherein the support-retaining strap gear comprises a first strap adapted to engage the support pad and an adjustment strap with buckles affixed at each end, wherein the positioning of the adjustment strap can be adjusted by drawing more of one end of the first strap though one buckle and withdrawing the other end of the first strap from the other buckle.

11. The roof-top carrier of claim 1, wherein the support-retaining strap gear is adapted to be situated 5 cm or less from the roof.

12. The roof-top carrier of claim 1, wherein the support-retaining strap gear is adapted to be situated 3 cm or less from the roof.

13. The roof-top carrier of claim 1, wherein the support-retaining strap gear is adapted to be situated 1 cm or less from the roof.

14. The roof-top carrier of claim 1, wherein the support-retaining strap gear is adapted to be situated a distance from the bottom of ⅓rd or less of a distance defined from the bottom to the top.

15. The roof-top carrier of claim 1, wherein the support members are straps situated in conduits that go through the support pad, and which straps are strapped around the support pad, wherein the conduits and strapping around acting to prevent a shift in positioning of the support members.

16. The roof-top carrier of claim I, wherein the support-retaining strap gear comprises one or more buckles substantially made of plastic.

17. The roof-top carrier of claim 1, comprising load-retaining strap gear (if not already present) and wherein the load-retaining strap gear comprises one or more buckles substantially made of plastic.

18. The roof-top carrier of claim 1, wherein the support pad comprises a slot adapted to engage a bar of a roof rack.

19. The roof-top carrier of claim 1, wherein the support pad comprises one or more slots for engaging gear to be carried on the roof-top carrier.

20. The roof-top carrier of claim 19, wherein one or more of the gear-engaging slots is adapted to engage a narrow dimension of two skis positioned base-to-base.

21. The roof-top carrier of claim 20, wherein one or more of the gear-engaging slots is adapted to engage rod-like segments of two ski poles, these gear-engaging slots having two channel segments adapted to position the ski poles in the gear-engaging slots.

22. The roof-top carrier of claim 21, wherein the one or more of the gear-engaging slots for skis and the one or more of the gear-engaging slots for poles are adapted to position the skis and poles below the top of the support pad, thereby leaving room on the top of the support pad to position one or more snow boards.

23. The roof-top carrier of claim 22, wherein there is room on the top of the support pad for two snow boards, and wherein the load-retaining strap gear comprises:
a centering strap adapted to be fitted to the roof-top carrier between the locations of the two snow boards; and
a side strap for each side of the roof-top carrier adapted to engage at one end the support-retaining strap gear at each side of the roof-top carrier, second ends of the side straps or corresponding ends of the centering strap attached to a buckle adapted to secure such ends together.

24. The roof-top carrier of claim 23, wherein the support-retaining strap gear comprises two rings, and the side straps comprise clips for engaging the rings.

25. The roof-top carrier of claim 24, wherein the roof-rack carrier comprises a centering strap-securing-strap strapped around the support pad and securing the centering strap, which centering strap-securing-strap can serve as a third support member.

26. The roof-top carrier of claim 19, wherein one or more of the gear-engaging slots is adapted to a reel and a portion of a pole of a rod and reel.

27. The roof-top carrier of claim 19, comprising a horizontal slot adapted to fit a surfboard, sailboard, snowboard, kiteboard or similarly shaped item.

28. The roof-top carrier of claim 27, wherein the horizontal slot is interior to the resilient support pad and accessible by a lateral slot that can be secured in a closed position by the support-retaining strap gear or load-retaining strap gear.

29. A method of securing boating gear while carrying the boat on a carrier, the method comprising:
securing a portion of the boat to the carrier with a strap that comprises two affixed rings, the securing locating the rings to two separate locations relative to a center line of the boat; and
securing the mast or mast and folded sail between the rings with strapping gear.
